(19) United States
(12) Patent Application Publication
(10) Pub. No.: US 2026/0085715 A1
(43) Pub. Date: Mar. 26, 2026

(54) SELF-LOCKING THREADED JOINT

(71) Applicant: CHUN NAN JIN-JI TECHNICAL CO., LTD., New Taipei (TW)

(72) Inventor: HUNG-CHANG CHU, New Taipei (TW)

(21) Appl. No.: 18/898,547

(22) Filed: Sep. 26, 2024

(51) Int. Cl. F16B 39/30

(52) U.S. Cl. CPC F16B 39/30

(57) ABSTRACT

A self-locking threaded joint mainly has an accommodating space, a plurality of internal screw threads are provided in the accommodating space, the internal screw threads are of equidistant pitches, an outer side of the self-locking threaded joint is provided with a plurality of recesses that are staggered and non-corresponding to one another, each of the recesses forms a collapsed portion at a position corresponding to the internal screw thread, a spoke is fixedly screwed in the accommodating space of the self-locking threaded joint, and through a curved threaded path generated by the collapsed portions that are staggered and not corresponding to one another, a path of the spoke is changed to limit the spoke, thereby capable of preventing the self-locking threaded joint and the spoke from loosening.

### BACKGROUND OF THE INVENTION

### Field of Invention

The invention relates to a self-locking threaded joint, more particularly to a self-locking threaded joint structure capable of preventing loosening.

### Related Art

It can be known from the conventional technology that it mainly forms two mutually symmetrical recesses on the outer side of the body of the threaded joint through processing, so that a narrow part is formed in the internal screw thread, and through the pressing and restriction of the narrow part, the spoke locked therein can be prevented from loosening. However, although the two mutually symmetrical recesses can form the narrow part to press and restrict the spoke, the narrow part is only in a single position, and the remaining threaded part is still a normal thread. Since the width of the narrow part is narrow, when a screw is ready to enter the narrow part, the narrow part may not be conducive to screw locking. Furthermore, because the two recesses are arranged symmetrically with each other, the thickness of the threaded joint body becomes smaller. Therefore, the vibration or pressing of an external force may cause the section of the threaded joint body to break, and the two recesses are symmetrical to each other and have a conical shape, so their effectiveness in pressing is very limited. In addition, because the recesses are arranged symmetrically with each other, when the spoke is screwed straight upwardly and downwardly, the thread at that position will be worn, resulting in loss of the pressing effect. Therefore, how to improve the drawbacks and tackle the problems mentioned above is the technical difficulty that the inventor of the invention wants to solve.

### SUMMARY OF THE INVENTION

A main object a self-locking threaded joint of the invention is that it mainly has an accommodating space, a plurality of internal screw threads are provided in the accommodating space, and the internal screw threads are of equidistant pitches, an outer side of the self-locking threaded joint is provided with a plurality of recesses that are staggered and non-corresponding to one another, each of the recesses forms a collapsed portion at a position corresponding to the internal screw thread.

In order to achieve the above object, wherein the recess of the self-locking threaded joint can be either a dot form or an area form.

In order to achieve the above object, wherein a width of the recess of the self-locking threaded joint needs to be at least greater than one pitch.

In order to achieve the above object, wherein a mutually staggered distance between two of the recesses of the self-locking threaded joint needs to be at least greater than 0.8 mm.

In order to achieve the above object, wherein a radian of the recess of the self-locking threaded joint is 30 [symbol] 180 degrees.

In order to achieve the above object, wherein a spoke is further provided with a plurality of external screw threads on an outer side surface thereof, and the spoke is fixedly screwed on the internal screw threads of the self-locking threaded joint through the external screw threads.

### BRIEF DESCRIPTION OF THE DRAWINGS

FIG. 1 is a cross-sectional view of the invention.

FIG. 2 is a first schematic diagram of a preferred embodiment of the invention.

FIG. 3 is a second schematic diagram of a preferred embodiment of the invention.

FIG. 4 is a third schematic diagram of a preferred embodiment of the invention.

FIG. 5 is a fourth schematic diagram of a preferred embodiment of the invention.

FIG. 6 is a first schematic diagram of a further embodiment of the invention.

FIG. 7 is a second schematic diagram of a further embodiment of the invention.

FIG. 8 is a third schematic diagram of a further embodiment of the invention.

### DETAILED DESCRIPTION OF THE INVENTION

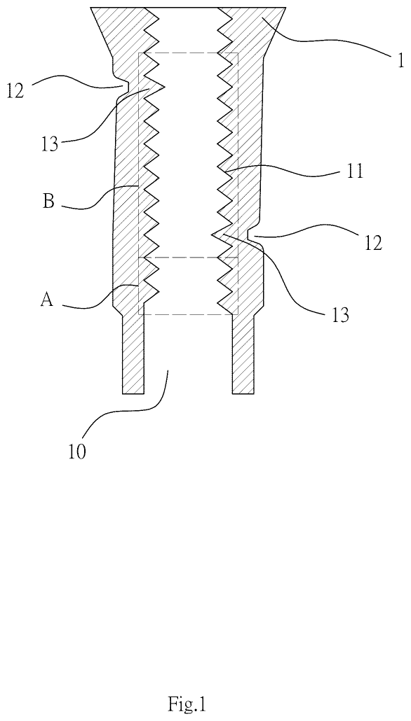

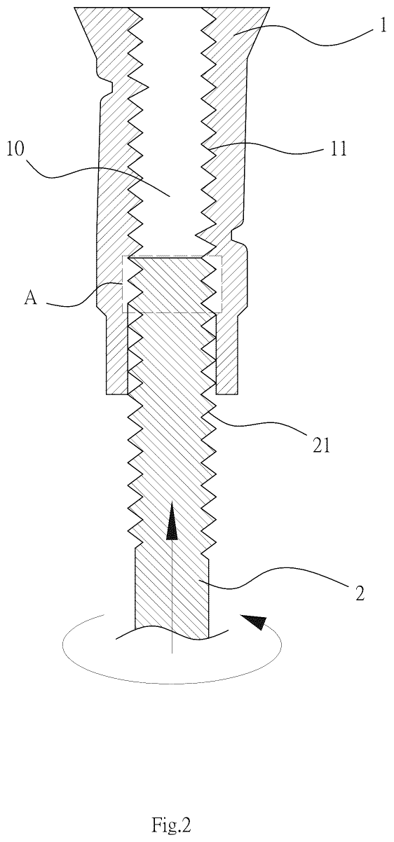

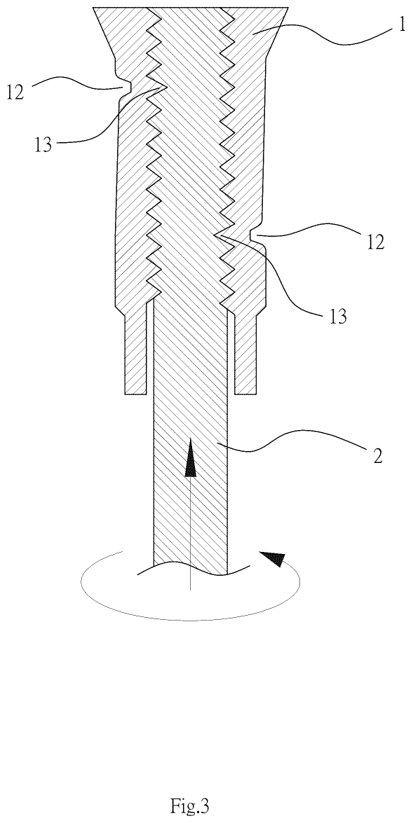

Please refer to FIGS. 1, 2, 3, 4, 5, 6, 7 and 8, which are a cross-sectional view, schematic diagrams of preferred embodiments and further embodiments of the invention. It can be clearly seen from the figures that the invention mainly comprises components mentioned hereinafter.

A self-locking threaded joint 1 has an accommodating space 10, a plurality of internal screw threads 11 are provided in the accommodating space 10, the internal screw threads 11 are of equidistant pitches, an outer side of the self-locking threaded joint 1 is provided with a plurality of recesses 12 that are staggered and non-corresponding to one another, and each of the recesses 12 forms a collapsed portion 13 at a position corresponding to the internal screw thread 11; and
a spoke 2 provided with a plurality of external screw threads 21 on an outer side surface thereof, the external screw threads 21 are of equidistant pitches, and the spoke 2 is fixedly screwed on the internal screw threads 11 of the self-locking threaded joint 1 through the external screw threads 21.

Wherein the recess 12 of the self-locking threaded joint 1 can be either a dot form and an area form.

Wherein a width of the recess 12 of the self-locking threaded joint 1 needs to be at least greater than one pitch.

Wherein a mutually staggered distance between two of the recesses 12 of the self-locking threaded joint 1 needs to be at least greater than 0.8 mm.

Wherein a radian of the recess 12 of the self-locking threaded joint 1 is 30 [symbol] 180 degrees, and the radian is an arc length angle corresponding to a circumference of the self-locking threaded joint 1.

Wherein a front end of the accommodating space 10 of the self-locking threaded joint 1 not provided with the collapsed portion 13 is a guide section A, and a rear end of the accommodating space 10 provided with the collapsed portion 13 is an interval section B.

Wherein the spoke 2 is further provided with the external screw threads 21 on the outer side surface thereof, and the spoke 2 is fixedly screwed on the internal screw threads 11 of the self-locking threaded joint 1 through the external screw threads 21.

In the invention, the spoke 2 is fixedly screwed on the internal screw threads 11 in the accommodating space 10 of the self-locking threaded joint 1 through the external screw threads 21, thereby combining the self-locking threaded joint 1 with the spoke 2. After the spoke 2 is screwed into the self-locking threaded joint 1, the recesses 12 that are staggered and non-corresponding to one another need to be provided on the outer side of the self-locking threaded joint 1 through processing. Moreover, each of the recesses 12 is further formed with the collapsed portion 13 at a position corresponding to the internal screw thread 11, thereby compressing and limiting the external screw threads 21 of the spoke 2 through the collapsed portions 13, and therefore capable of preventing the spoke 2 from detaching from the self-locking threaded joint 1.

Based on the above, a reason why the recesses 12 on the outer side of the self-locking threaded joint 1 need to be disposed in a manner of being staggered and non-corresponding to one another is mainly to create non-linear and curved pressing and restriction through the corresponding collapsed portions 13. That is to say, pressing caused by each of the collapsed portions 13 is not at a same position. When the spoke 2 is pressed and restricted by a non-linear and curved shape, it is extremely difficult for the external screw threads 21 of the spoke 2 to detach from the internal screw threads 11 of the self-locking threaded joint 1.

In addition, as shown in the figures, when the spoke 2 is screwed into the accommodating space 10 of the self-locking threaded joint 1, the spoke 2 first passes through the guide section A of the accommodating space 10. Because the accommodating space 10 of the guide section A only has the internal screw threads 11, the spoke 2 can be easily screwed into the accommodating space 10. After the spoke 2 begins to enter the interval section B of the accommodating space 10, since the interval section B has the collapsed portions 13 in addition to the internal screw threads 11, the spoke 2 needs to be strengthened with a screw locking force in order to enter into the accommodating space 10. A reason for this design is mainly to enable the spoke 2 to enter into the accommodating space 10 at the front end through guidance of the guide section A; although the interval section B makes it more difficult for the spoke 2 to be subsequently screwed through the collapsed portions 13, it is also difficult for the spoke 2 to detach from the accommodating space 10 due to difficulty of screwed locking.

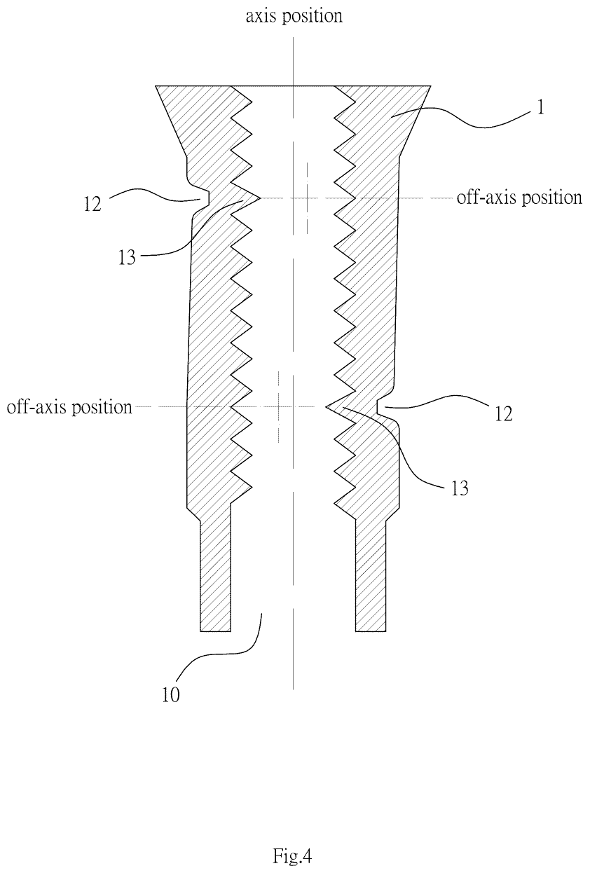

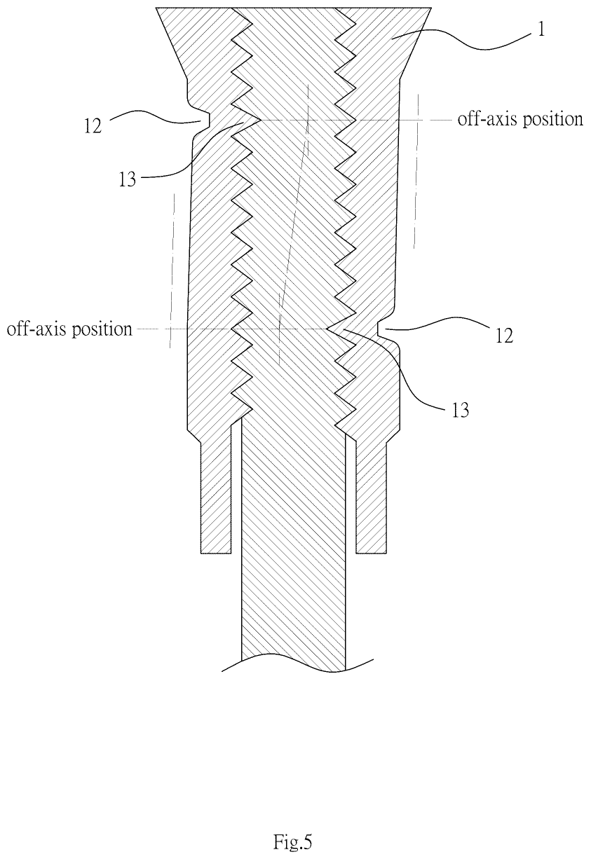

In addition, as shown in FIGS. 4 and 5, it can be seen that a center of the accommodating space 10 of the self-locking threaded joint 1 is an axis position. Because the collapsed portions 13 in the interval section B are pressed inwardly, an axis position of the interval section B is in an offset state. When the spoke 2 is screwed into the accommodating space 10 of the self-locking threaded joint 1, through pressing of the collapsed portions 13 of the interval section B, the spoke 2 produces an eccentric state and a curved thread path, and therefore the spoke 2 needs to be strengthened with a screw locking force in order to enter into the accommodating space 10, it is also difficult for the spoke 2 to detach from the accommodating space 10.

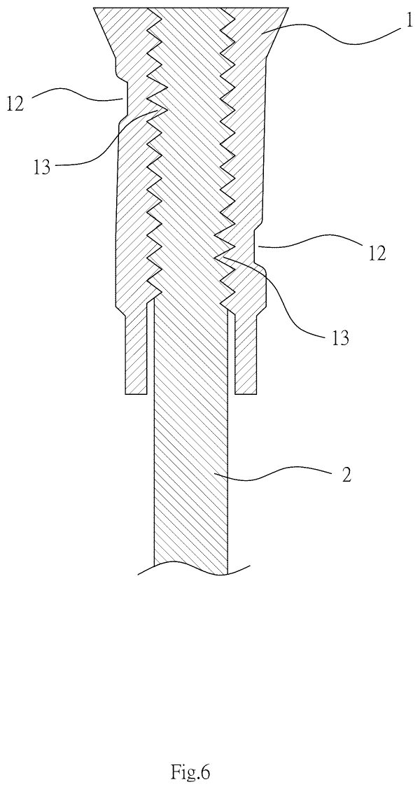

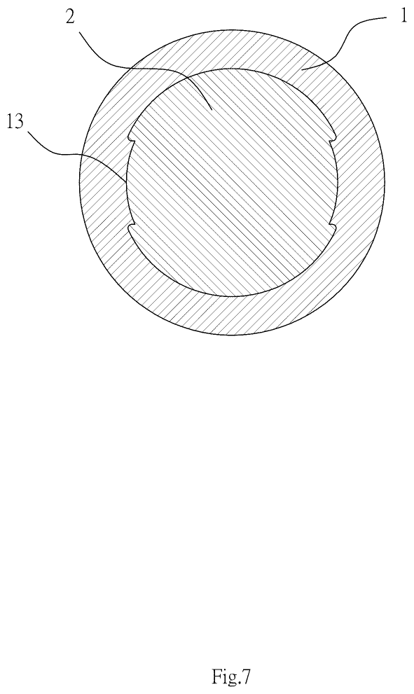

In addition, in the above figures, the recesses 12 provided on the outer side of the self-locking threaded joint 1 are in a form of dot. As shown in FIGS. 6 and 7, the recesses 12 are in a form of area. In addition to a width of the recesses 12 being larger than that of the recesses 12 in dot form, a length thereof is more than a distance of one pitch. As can be seen from the figures, the recesses 12 are also disposed on the outer side of the self-locking threaded joint 1 and at positions that are staggered and non-corresponding to one another, causing the spoke 2 to be restricted by a non-linear and curved threaded path.

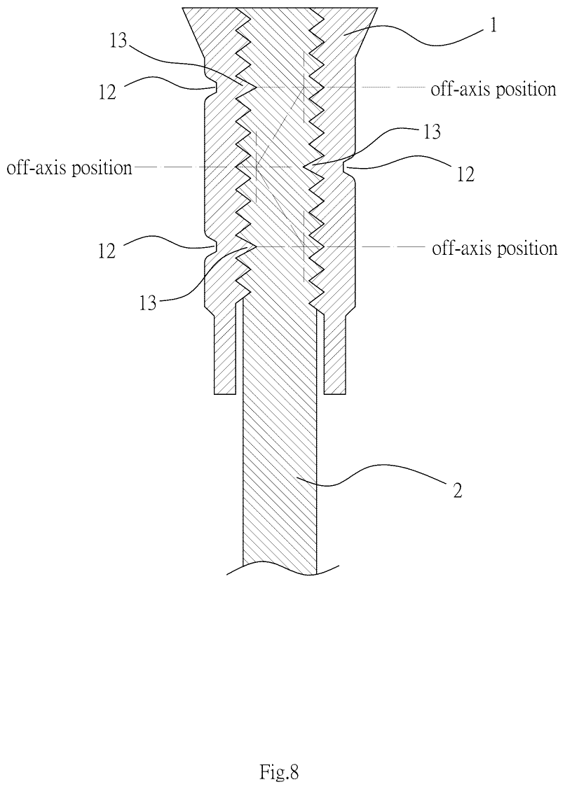

In addition, in the aforementioned figures, the self-locking threaded joint 1 is provided with the two recesses 12 that are staggered and non-corresponding to each other on the outer side. As shown in FIG. 8, the three recesses 12 being staggered and non-corresponding to one another are provided, a same efficacy of creating non-linear and curved pressing and restriction through the collapsed portions 13 corresponding to the recesses 12 can be achieved, which is capable of preventing the self-locking threaded joint 1 and the spoke 2 from loosening.

Summing up the above, compared with the drawbacks caused by the conventional threaded joints when they are combined with the spoke, and the problem of the thread being worn when the spoke is screwed straight upwardly and downwardly; the invention uses a special design between the self-locking threaded joint 1 and the spoke 2 to create a non-linear and curved threaded path through the recesses 12 that are staggered and non-corresponding to one another and provided on the outer side of the self-locking threaded joint 1, further achieving an effect of limiting a threaded path of the spoke 2 and pressing the spoke 2 tightly, and therefore the self-locking threaded joint 1 and the spoke 2 can be prevented from loosening, and further preventing the spoke 2 from detaching from the self-locking threaded joint 1 due to vibration or pressing by an external force.

The above-mentioned embodiments are used to illustrate one of the feasible preferred embodiments of the invention and are not intended to limit the scope of the invention. Any person having ordinary in the art can make changes and modifications without departing from the spirit and scope of the invention. Therefore, the scope of protection of the invention shall be determined by the appended claims.

What is claimed is:

1. A self-locking threaded joint having an accommodating space, a plurality of internal screw threads being provided in the accommodating space, the internal screw threads being of equidistant pitches, an outer side of the self-locking threaded joint being provided with a plurality of recesses staggered and non-corresponding to one another, and each of the recesses forming a collapsed portion at a position corresponding to the internal screw thread.

2. The self-locking threaded joint as claimed in claim 1, wherein the recess can be either a dot form or an area form.

3. The self-locking threaded joint as claimed in claim 1, wherein a width of the recess needs to be at least greater than one pitch.

4. The self-locking threaded joint as claimed in claim 1, wherein a mutually staggered distance between two of the recesses needs to be at least greater than 0.8 mm.

5. The self-locking threaded joint as claimed in claim 1, wherein a radian of the recess is 30 [symbol] 180 degrees.

6. The self-locking threaded joint as claimed in claim 1, wherein a front end of the accommodating space not provided with the collapsed portion is a guide section, and a rear end of the accommodating space provided with the collapsed portion is an interval section.

7. The self-locking threaded joint as claimed in claim 1, wherein a spoke is further provided with a plurality of external screw threads on an outer side surface thereof, and the spoke is fixedly screwed on the internal screw threads of the self-locking threaded joint through the external screw threads.
